(19) United States
(12) Patent Application Publication
(10) Pub. No.: US 2005/0287513 A1
(43) Pub. Date: Dec. 29, 2005

(54) Method for preserving intracellular molecular detail

(76) Inventors: Ashley S. Davis, Denver, CO (US); Kim M. Middleton, Denver, CO (US)

Correspondence Address: CYTOSKELETON INC.;ATTN: ASHLEY DAVIS, 1830 S. ACOMA ST., DENVER, CO, 80223, US

(21) Appl. No.: 10/696,023

(22) Filed: Oct. 30, 2003

(51) Int. Cl. A01N 1/02

(52) U.S. Cl. 435/2

(57) ABSTRACT

A process and composition is described that allows the operator to fix and preserve tissue culture grown cells such that their intracellular molecular detail is retained for up to four years. This enables increased reproducibility of staining for antigens and small molecule targets for use in the areas of basic research and diagnostic applications.

Keywords: 1. molecular structure detail, 2. molecular-scale detail, 3. intracellular molecular structure detail, 4. nanometer-scale detail. 5. immunofluorescence staining. Abreviations: FCS=Fetal calf serum. PBS=Phosphate Buffered Saline. DMEM=Dulbecco's modified Eagle's Medium. LPA=lysophosphatidic acid. PDGF=Platelet Derived Growth Factor.

### FIELD OF THE INVENTION

Immunological examination of tissue culture cells is important in diagnosing diseases and for basic cell biology where it is used to identify the presence and location of specific antigens. Tissue culture cells are normally fixed prior to staining with antibodies, however this process only allows up to one week of storage prior to staining. The ability to preserve fixed cells with a shelf life of greater than one year at 4° C. would allow improvement in consistency in control slides for experimental and diagnostic applications. The present invention relates to a process patent for the manufacture of tissue culture cells that are preserved for extended shelf life. In addition, the present invention describes a process of preserving the intracellular molecular-scale detail which allows a) identification of single microtubules (25 nanometers in diameter) and b) identification of the correct conformation of F-actin (nanometer-scale detail) even after one year's storage at 4° C.

### BACKGROUND OF THE INVENTION

In cell biology research and clinical diagnostic applications, immunological analysis of tissue culture preparations are paramount importance in identifying antigens. In clinical diagnostics, it is presently the case that the presence or absence of an antigen is sufficient to identify a disease state. This is the case in analysis of cancer and HIV by cluster designation (CD) antigens. For example U.S. Pat. Nos. 5,849,517, 5,648,222 or 6,004,762 describe a method to preserve cells in a liquid state that are suitable for immunological investigation by flow cytometry with a shelf life up to one week. Antigens can consist of cells, cell components, proteins, and nucleic acids. Up to the present, cells have been preserved in the living state so that they may be grown after storage (U.S. Pat. Nos. 4,559,298 and 5,879,875) and cells have been preserved for histology using formaldehyde cross-lining reagents (U.S. Pat. No. 5,059,518) or urea derivatives (U.S. Pat. No. 5,849,517). All of these methods produce samples with preserved antigenicity on a whole cell scale but do not preserve the spatial structure of the antigens at the sub-cellular level nor the nanometer scale detail of single proteins. In fact, U.S. Pat. No. 6,004,762 describes the technique to actively discourage molecular detail (see end of paragraph 10 in the Detailed Description, where it is written that the authors use a temperature of 0 to 10° C. to create a situation that is “preventing the polymerization of microtubules”. See also Kreis and Vale 1993). In contrast the present invention describes a method to retain this molecular detail by using warn conditions (see Carraway and Carraway 1992) and other fixatives in combination with the preservation procedure described here.

Another example is that U.S. Pat. No. 5,849,517 uses liquid state conditions for fixation and Fluorescence Activated Cell Sorting (FACS) analysis (see FIGS. 2 and 3 in U.S. Pat. No. 5,849,517). Molecular scale detail is not required for FACS analysis, this is what is called a whole cell staining procedure i.e. measuring the fluorescence from the entire cell as one quantity, in this respect any procedure using FACS does not distinguish molecular detail.

Another example is U.S. Pat. No. 5,059,518 which freezes cells in solution and then the inventor performs lyophilization, these preparations are used for FACS analysis also (see FIG. 1 to 4 in U.S. Pat. No. 5,059,518) there is no molecular detail presented here either so one assumes there is no molecular structure detail left in these preparations. Another example is U.S. Pat. No. 6,004,762 which uses paraformaldehyde to fix cells, in contrast the present invention reports that this fixative is not suitable to retain molecular-scale detail (F-actin protein conformation). Another example is that none of the above mentioned patents use cells that are fixed and preserved on to solid surfaces (e.g. glass slides) which is described in the present invention.

The words “fixed” and “preserved” must be defined at this stage for clarity. “Fixed” is defined as some means to immobilize the cells and antigens therein which enables immediate (less than one week) analysis of antigens by immunological examination. There have been many and varied reports of fixation and this is not the focus of the present invention. “Preserved” is defined as a state of fixed cells that allows a shelf life of greater than one week after which point the preparation may be used for immunological examination as if they were freshly prepared. Preservation is the focus of the present invention.

Cells grown is tissue culture can be fixed by a variety of procedures (see Celis 1994) but two types are commonly used. First proteins in the cell are chemically crosslinked with paraformaldehyde, formaldehyde or glutaraldehyde, and secondly organic solvent precipitation of cellular proteins, both procedures retain the structure within cells for periods of up to one week. Crosslinking chemicals cause cross linking of intracellular components making the intracellular matrix more stable for immediate immunological analysis. Organic solvent fixation (e.g. methanol fixation), precipitates the intracellular proteins in close proximity (<500 nm) from their original location. Both procedures are useful in particular instances, methanol is used as a quick procedure so it is useful at fixing labile components in the cell such as fixing microtubules. Glutaraldehyde is useful for fixing smaller proteins which may be solubilized by methanol treatment, and it is more likely to retain the native conformation of protein which may be important for probing with labels such as rhodamine phalloidin (see later).

The fixation techniques described above are laboratory procedures whereby the cells are fixed and then processed in a short timeframe, usually less than one week. For this purpose fixed cells maybe stored at 4° C. for a day or at −20° C. for 1 week, however times longer than this or higher temperatures, such as room temperature, negatively impacts the results by disrupting structure and collapsing cell architecture. In addition it is presently accepted that drying the preparations (similar to lyophilization) is not considered good practice and results in damaged cell morphology (Celis 1994). The previously mentioned patents describe whole cell analysis where molecular-scale detail is not required. However molecular scale detail is of critical importance for probing tissue culture cells in research and future diagnostic applications, therefore the previously patented techniques cannot be used in place of the present invention.

The present invention describes a method of producing greater than 1000 uniform slides containing preserved tissue cultured cells for immunological examination. The slides are stable for up to six months at room temperature without any loss in intracellular structures and molecular structure detail. Longer storage times of 1 to 2 years are expected based on extrapolation of stability data at elevated temperatures. In addition, we have shown different physiological states (e.g Rho, Rac and Cdc42 activation) are exquisitely preserved with fine structural and molecular structure detail for many months at 4° C. Several cell types have been preserved successfully (Swiss 3T3, HeLa and HT1080) using methanol or glutaraldehyde or a combination of both fixation techniques. It is likely that other cell types can be successfully preserved using a similar technique. These preparations can be used in diagnostic kits and cell biology research where preserved intracellular detail and molecular structure are critically important.

The time line of the invention is as follows:

1. In 1998 it was discovered that the same composition of sucrose and dextran that is used to preserve protein structure in Cytoskeleton Inc.'s protein products line, was also useful to preserve some detail of intracellular structural integrity.

2. In 1999 it was shown that leaving out the sucrose and dextran was a severe limitation to retaining the structural integrity, but also there was large variation between batches.

3. In 2000 the project languished because the company was moving facilities.

4. In 2001 the project was re-ignited and more uniformity was obtained between batches i.e. better protocols.

5. in 2002 the project expanded to other cell lines and other cell treatments and other fixative agents.

6. In 2003 the present application was submitted and two publications are forthcoming Biotechniques November 2003 (submission date).

### DESCRIPTION OF THE DRAWINGS

FIG. 1—Schematic diagram of the process of making the preserved cells. Filename on CD: FIG. 1.pdf. The process is broken down into eight steps, these are Culture, PBS wash, Fixation, PBS wash, Equilibrium, Preservation, Packaging and Storage. The equilibrium, preservation and storage are unique to this invention. Depending on the cell line, culture conditions and fixative may vary, the equilibrium is performed with a PBS bufferd solution containing a stabilizing sugar (e.g. sucrose) and a carbohydrate polymer (e.g. dextran).

FIG. 2—Optimization of fixative solutions. Filename on CD: FIG. 2—Fixation conditionsCMYK.tif. Swiss 3T3 cells were grown on glass slides and the following fixative solutions were compared to see which one retains the best intracellular molecular details, A—water, B—PBS, C—3.7% paraformaldehyde, D—1% formaldehyde, E—1% glutaraldehyde, and F—100% Methanol. All samples were preserved with the optimal preservative described in FIG. 3F and stored for one month at 4° C. The images represent either cell debris or intact cells stained with anti-tubulin antibody (Cat# ATN02 from Cytoskeleton Inc.) followed by rhodamine anti-sheep secondary antibody (Cat# SG02 from Cytoskeleton Inc.). Arrowheads indicate areas of highly preserved molecular structure detail whereas arrows indicate areas of poor preservation where cell breakage has occurred. A,B and C indicate there are no intact cells remaining after water, PBS or paraformaldehyde fixative treatment. D, E and F indicate intact cells when using formaldehyde, glutaraldehyde or methanol. In D, E and F there is fine molecular detail preserved just as if the cells had been freshly fixed. The preparation in FIG. 2D lost molecular detail over the course of one month, probably representing the lower crosslinking levels afforded by formaldehyde compared to glutaraldehyde or methanol. The white bar in the lower left of A represents 10 micrometers.

FIG. 3—Optimization of the preservative. Filename on CD: FIG. 3—Preservative componentsCMYK.tif. Swiss 3T3 cells were grown on glass slides, fixed with methanol and used to test various preservation parameters for retaining molecular detail. Slides were treated with each preservative and then frozen in a −20° C. freezer unless specified, and lyophilized overnight. Preservation reagents were A—Water, B—PBS, C—PBS and 1% (w/v) dextran (68 K dal), D—PBS plus 5% (w/v) sucrose, E—PBS plus 5% (w/v) sucrose and 1% (w/v) dextran, and F—same as E except rapid frozen in a −70° C. freezer. The images represent either cell debri or intact cells stained with 1;200 diluted anti-tubulin antibody (Cat# ATN02 from Cytoskeleton Inc.) followed by 1:200 diluted rhodamine anti-sheep secondary antibody (Cat# SG02 from Cytoskeleton Inc.). Observe the dark round region in the center of each stained area this represents the intact nucleus (some are labeled with N), the stained area in intact cells represents the cytoplasm where the majority of tubulin staining is found in the form of microtubules (stringy looking structures). Note in A,B and C, the lack of cells and hence no molecular detail. Note in D, the presence of cells but the lack of molecular detail. Note in E and F the presence of cells with exquisite molecular detail. The arrowheads indicate single microtubules which are only 25 nanometers in diameter or 5 to 6 tubulin protein molecules in width (microtubules are cylinders of 13 to 14 tubulin molecules in circumference). Cells were better preserved with rapid freezing (F) when compared for less damaged cells, this was probably due to more ice crystals forming with the slow freezing method. See damaged areas labeled with “d” where the cells have pieces missing, more damaged examples are shown later in FIG. 4 where an abrasion test is performed.

FIG. 4—Abrasion test for robustness. Filename on CD: FIG. 4—Abrasion test.tif.

In order to incorporate knowledge of robustness into the invention we performed abrasion tests on lyophilized preparations. A—is the control no abrasion. B is a light knocking of the slide without actual contact of the powdery surface of the slide. C is a light rubbing of the powdery surface of the slide. D is scratched to the glass surface. The images represent either cell debri or intact cells stained with anti-tubulin antibody (Cat# ATN02 from Cytoskeleton Inc.) followed by rhodamine anti-sheep secondary antibody (Cat# SG02 from Cytoskeleton Inc.). Short arrows represent cracks in the cells that are caused by some contact in C or at the edge of a scratch in D. The long arrow represents the direction and orientation of the scratch. The conclusion from this experiment is that the preparation is suitable for shipping and handling where the surface can be in minimal contact with the packaging allowing a slight amount of abrasion.

FIG. 5—Shelf life study. Filename on CD: Shelf life studyCMYK.tif.

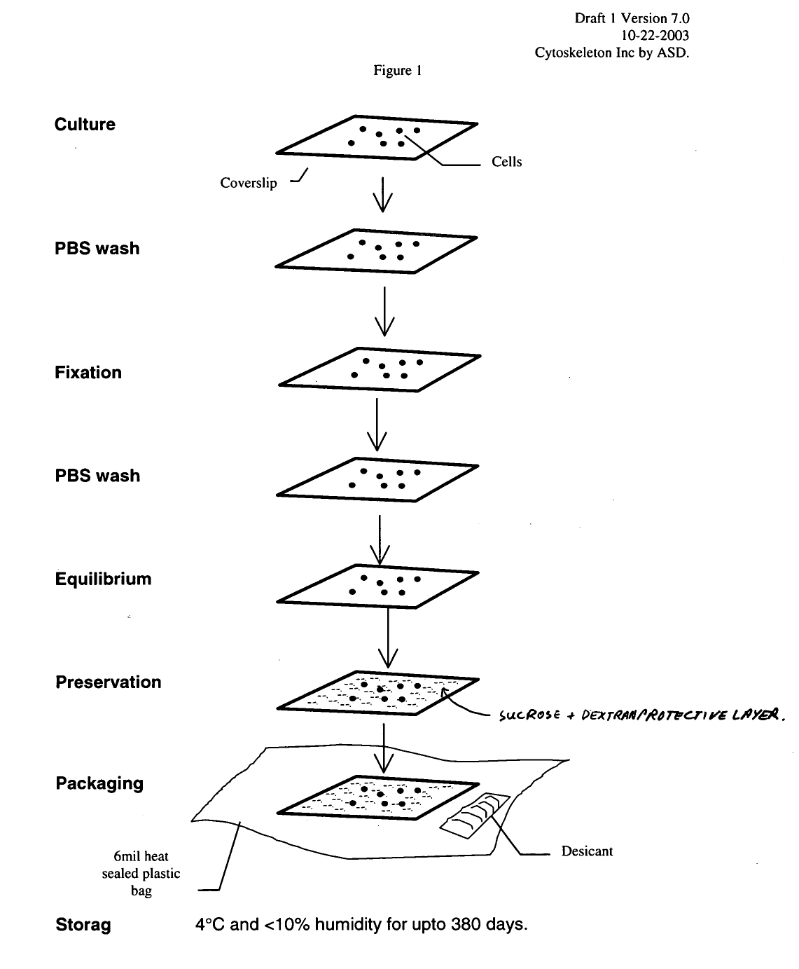

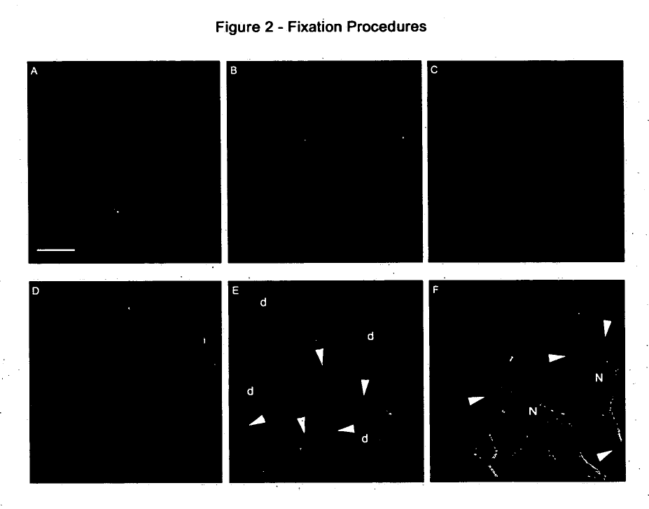

In order to be a value commodity the cell preparations must have a shelf life of at least one year. Here we show a batch of Swiss 3T3 that was fixed with methanol, preserved with the same composition as FIG. 2F and stored as described in FIG. 1 at 4° C. or 37° C. for up to 180 days (number noted on the left of the figure). The images represent intact cells stained with anti-tubulin antibody (Cat# ATN02 from Cytoskeleton Inc.) followed by rhodamine anti-sheep secondary antibody (Cat# SG02 from Cytoskeleton Inc.). Normal storage temperatures are 4-8° C., whereas 37° C. is used as an accelerated study temperature which is equivalent to eight times the duration at 4° C. (Q₁₀ rule=for every 10° C. increase in temperature there is a two fold increase in reaction rate for a first order reaction in the First Law of Thermodynamics [Cell Biology 1979 p125-128 and 152]). Therefore 180 days at 37° C. is equivalent to 1440 days or 3.95 years at 4° C. There are intact structures showing molecular detail at all time points up to 180 days at 37° C. indicating that 4 years of storage at 4° C. is feasible.

FIG. 6—Preserved Swiss 3T3 cells stained with anti-tubulin, anti-actin and rhodamine phalloidin. Filename on CD: FIG. 6—Swiss3T3 anti-Tub-Act-PhallCMYK.tif.

Our model cell line Swiss 3T3 was used to test different fixatives for their effects on downstream stains. Anti-tubulin and anti-actin stains probe for all tubulin protein or actin protein respectively. Whereas rhodamine phalloidin stains only filamentous actin which has preserved actin conformation (i.e. a non-denatured or native protein conformation), this extra depth of molecular detail indicates that the preservation technique preserves not only intracellular localization but also the actual conformation of the protein in each cell. Cells were stored for one month at 4° C. before this study because earlier time points were more comparable for rhodamine phalloidin staining i.e. had not denatured in the methanol sample upto this point. However the increased shelf life is apparent at this one month time point by good staining with rhodamine phalloidin in the glutaraldehyde sample. There is good staining with anti-tubulin and anti-actin in both fixation procedures (see intracellular molecular detail in A,B,D and E), however only the glutaraldehyde fixation (in combination with the preservation method) retains the actual conformation of the original actin molecules so that it can bind rhodamine phalloidin, compare C with F. The brighter staining in F indicates much more retained protein conformation compared to C. Therefore two procedures are delineated, one with methanol which is suitable for all antibody staining because it permeabilizes cells and allows probing into even nuclear regions. The other method with glutaraldehyde is suitable where the actual protein conformation (another depth of molecular detail) is required for small molecule probing. Of course both procedures must be performed in combination with the optimized preservation method described here in order to last longer than one week at 4° C.

FIG. 7—Preserved HeLa cells stained with anti-tubulin, anti-actin and rhodamine phalloidin. Filename on CD: HeLa anti-Tub-Act-Phall-02.tif

All conditions and procedures were the same as described in FIG. 6. HeLa cells (human cervical cancer) respond differently to methanol fixation than Swiss 3T3. In general with methanol fixation the cellular and intracellular detail is lost, and cells shrivel up on the slide (see A,B,C). In contrast the glutaraldehyde fixation results in intact cells with intracellular molecular detail (see D,E,F). There was a common finding that the less adherent cells (HeLa is less adherent than Swiss 3T3) were recalcitrant to the methanol treatment, but had adequate intracellular detail with glutaraldehyde. This was shown even more clearly with MCF7 which is less adherent than HeLa (see FIG. 9) where other methods had to be employed. These cells were stored for 6 weeks at 4° C. before analysis.

FIG. 8—Preserved HT1080 cells stained with anti-tubulin, anti-actin and rhodamine phalloidin. Filename on CD: HT1080 anti-Tub-Act-Phall-02.tif.

All conditions and procedures were the same as described in FIG. 6. Cells were stored for three months prior to analysis. HT 1080 were similar to HeLa cells in that they were not fixed effectively with the methanol procedure (see only cell debris in A,B,C), but the glutaraldehyde method worked well (see D,E,F).

FIG. 9—Use of poly-lysine coated cells to preserve MCF-7 cells. Filename on CD: Recalcitrant cell linesCMYK.tif.

All conditions and procedures were the same as described in FIG. 6 except that only anti-tubulin staining was used. Cells were stored 6 weeks prior to analysis. Untreated slides were used in A, D and E, and poly-lysine coated slides (1 mg/ml for 5 min, followed by three PBS washes) were used in B,C and F. In this example there is no cellular structure retained in A,D or E, however using poly-lysine and quick fixation by methanol in combination with the preservation technique described here resulted in exquisite molecular detail remaining (see microtubule structures in the intact cell in panel B). This indicates that cells that are difficult to preserve with the preferred procedure can be preserved by modifying the growth substrate. Additional methods to enhance preservation may include deriving strongly attaching cell lines or altering media components to increase attachment to the glass slides. C and F show additional mitotic cells of MCF-7 using poly-lysine coated slides.

FIG. 10—Preservation of apoptotic cells. Filename on CD: HT1080 and apoptosis-03.tif

As a possible diagnostic tool, apoptotic cells are a model system for analysis. Here we show HT1080 to be well preserved by glutaraldehyde and preservation method described in FIGS. 8D,E and F. Cells were stored for 3 weeks prior to analysis. Paclitaxel was added to cultures 24 h hours before fixation which was sufficient to induce apoptosis. A clear signal of apoptosis is blebbing of nuclear material as clearly seen at the arrowheads in B. In apoptotic cells cytoskeletal architecture is lost, so there is not much detail to be seen when staining with anti-tubulin as in D. Clearly the staining procedure is working as represented by clear microtubule structures seen in the normal preserved cells as shown in C.

FIG. 11—Preservation of mitotic cells. Filename on CD: MitoticCMYK.tif.

All conditions and procedures were the same as described in FIG. 6 except that anti-tubulin and DAPI staining were used and the time in storage was 1 month. Approximately 1-3% of cells are undergoing mitosis at any one instant during cell culture (therefore its difficult to find more than one per image), mitotic cells are in the process of dividing genetic material to form two nuclei which then form individual nuclei for two daughter cells in a process called cytokinesis. Mitosis can be broken down into sub-stages called Prometaphase, Metaphase, Anaphase and Telophase (Cell Biology 1979 p697). The cell in this image is in the telophase of mitosis which means the genetic material has already separated and is being pushed further apart by the mitotic spindle. An abundant component of the mitotic spindle is tubulin, so using anti-tubulin antibodies we can see the molecular detail of the spindle. Clearly the preservation process described here is retaining the mitotic detail. Many Cyclins and other mitotic proteins are expressed or degraded specifically in mitosis so this makes an excellent tool to probe for the location and abundance of there components. Other mitotic cells are shown in FIGS. 9C and 9F.

FIG. 12—Preservation of growth factor stimulated cells. Filename on CD: Activated 3T3CMYCK.tif. Swiss 3T3 cells were grown in normal culture conditions (A), or treated with “no serum” media (B), then exposed to growth factors for 10 min, lysophosphatidic acid (LPA) (C), platelet derived growth factor (PDGF) (D) or tumor necrosis factor alpha (TNFa) (E). After 10 min treatment the cells were fixed, preserved with the optimal procedure described in FIG. 2F and stored for one month at 4° C. The cells responded normally to these treatments (compare with Ridley and Hall 1993) and the preservation technique retained the intricate molecular detail associated with each growth factor's appropriate response. Cell preparations were fixed with glutaraldehyde so they could be probed with rhodamine phalloidin to detect conformationally active actin protein in the form of stress fibers (see arrowheads in A). “No serum” control cells had very few stress fibers (see arrows in B). Actin stress fibers were appropriately observed in LPA treated cells (see arrowheads in C). Actin accumulation was appropriately observed in PDGF treated cells (see arrowheads in D). And micro-spikes containing actin fibers were observed as expected in TNFa treated cells (see long arrows in E).

FIG. 13—Use of preserved Swiss 3T3 cells as a tool to investigate basic biological questions. Filename on CD: FibronectinCMYK.tif.

As an example of using the present invention in basic biology, we probed preserved Swiss 3T3 cells treated with the same growth factors as described in FIG. 12. The cells were probed this time with rhodamine fibronectin. Fibronectin is known to bind at focal adhesion plaques which are cell originating points of attachment between the cell and the growth surface. By adding 20 ug/ml of rhodmine fibronectin in PBS to each slide for 20 min at room temperature we were able to identify the focal adhesions in LPA activated cells only. Normal grown cells, PDGF and TNFa treated cells all had diffuse cytoplasmic staining whereas “no serum” grown cells had a slightly more intense cytoplasmic staining. This indicates that these preparations have retained fibronectin binding sites and that the binding sites coalesce when cells are treated with LPA to focal adhesion plaques which is similar to the original observation of these cells by Nobes and Hall (1995).

FIG. 14—Presentation of the final product and packaging. Filename on CD: Final ProductCMYK.tif. FIG. 1A shows the final product presented for inspection in an open box. There are six 24 mm×24 nm glass slides containing preserved cell on the surface (see white powdery material). This box is closed and packaged with a Trisorb (Sud-Chemie Inc.) desiccant (1 unit per box) and locked into a 6 mil thick polythene zip-lock bag. This construction will preserve the product for 12 months in a 4° C. cooler, which is usually 100%-humidity environment because of condensation inside the cooler. The product remains at <5% humidity because of the desiccant enclosed in the 6 mil thick polythene bag. Note how the CellVizion logo integrates the name and form of the final product by showing clear molecular-scale detail on the schematic slide.

### DETAILED DESCRIPTION OF THE INVENTION

The process of preserving long lasting cell samples for immunological examination requires several steps that are detailed in FIG. 1. Briefly cells are cultured on glass slides, washed with iso-temperature phosphate buffered saline (37° C. temperature pre-warmed PBS), fixed with methanol or glutaraldehyde or a combination of both, washed with PBS, then immersed in preservative. After placing at −70° C. for 30 min (rapid freezing) the cells are lyophilized for 16 h and packaged in a dry environment.

Indicators of Intracellular Molecular Detail:

Microtubules are structural components of cells that are composed of a 25 nm cylindrical arrangement of tubulin protein (see Microtubule Proteins, Academic Press Inc. NY. Editor J. Avila 1992). Microtubule are labile structures and they fall apart or depolymerize when perturbed, for example using colder PBS wash e.g. 0-10° C. as in U.S. Pat. No. 6,004,762 result in ablation of microtubules and hence loss of molecular structure detail. This characteristic is exploited in this invention by using an antibody that specifically recognizes microtubules and hence detects whether the structures are perturbed under certain conditions. They make a sensitive nanometer-scale indicator of preserved molecular scale detail. Likewise filamentous actin or F-actin is a 7 nm helical rope like arrangement of actin protein. In the correct conformation F-actin binds rhodamine-phalloidin a fluorescent low molecular weight compound (c. 800 daltons), in the non-native conformation actin will not bind to rhodamine-phalloidin. Probing with this compound thus forms another sensitive test of intracellular molecular structure detail.

Cells are cultured in appropriate medium depending on their nutritional requirements. For HT 1080 cancer cells used here, F-12 medium plus 10% fetal calf serum is used for all sub-culturing, whereas for Swiss 3T3 DMEM media plus 10% FCS is used. Cells are grown to half full density (i.e. half covering the surface that they adhere to), then they are washed with iso-temperature PBS to remove culture media. Iso-temperature PBS also preserves intracellular molecular structure detail because using a colder PBS wash e.g. 0-10° C. as in U.S. Pat. No. 6,004,762 would result in microtubule depolymerization and loss of molecular structure detail (as described above).

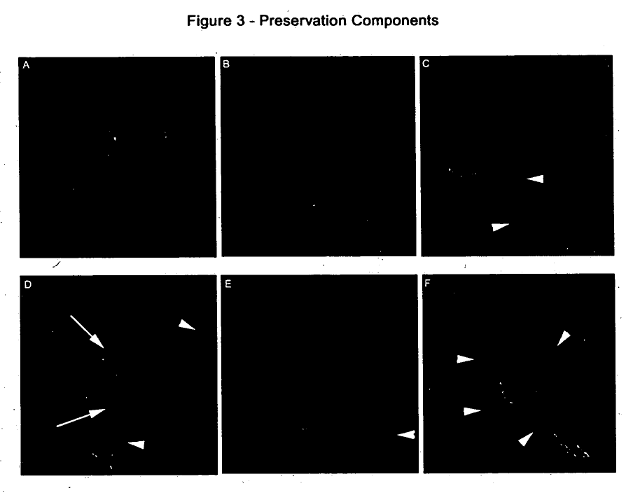

Fixative can be either methanol for 24° C. for 2 min, or glutaraldehyde (or a mixture of glutaraldehyde and methanol) for 24° C. for 20 min. Cells are again washed in PBS and then 150 ul of preservative solution is pipetted carefully on top of the coverslip. Preservative solution is optimally 10% PBS, 5% sucrose, 1% dextran in Milli-Q water (10⁻¹⁸ ohm) but these components can be altered or replaced with other components that provide the same function i.e. PBS is a buffer, sucrose stabilizes structure during freezing and lyophilization, and dextran provides extra support for molecular structure during long term storage. Samples are placed in −70° C. freezer to freeze rapidly (−20° C. freezing is not optimal as shown in FIG. 3) and then lyophilized using a standard Virtis machine with shelves. Lyophilization is at −40° C. initially and then later the temperature is raised to room temperature to completely sublime the water. After lyophilization, packaging is accomplished using 6 mil (six thousandths of an inch) thick plastic bags containing a one unit Trisorb (Sud-Chemie Inc.) desiccant pouch, which are heat sealed or zip-locked to retain the humidity at less than 5% saturation. The lyophilized preservative solution now protects the cells by creating a layer of dry sucrose which is about 2 millimeters deep, this is compared to the depth of the cell layer which is usually less than 10 micrometers.

Analysis of Results

FIG. 2 indicates that there are no intact cells remaining on the glass slide after water, PBS or paraformaldehyde fixative treatment. FIG. 2 D, E and F indicate intact cells remain when using formaldehyde, glutaraldehyde or methanol. In D, E and F there is fine molecular structure detail preserved as shown by anti-tubulin antibody which stains microtubules. The preparation in FIG. 2D (formaldehyde fixation) lost molecular detail over the course of one month, probably representing the lower crosslinking levels afforded by formaldehyde compared to glutaraldehyde or methanol. This gradual loss of molecular-scale detail was also observed in slides stained with rhodamine phalloidin (see FIG. 6 description below) indicating it was a general phenomena and not limited to the microtubule or actin structures alone.

Next we optimized the preservative component by comparing water, PBS, sucrose, dextran, sucrose and dextran and a rapid freeze. Sucrose or dextran were essential for preservation of intracellular molecular detail. Although some detail remained with PBS, it wasn't sufficient to follow the whole cell shape. The lack of sucrose and using dextran only resulted in breakages in cell architecture (see FIG. 3D) indicating that sucrose is required for the efficient retention of molecular structure detail. The −70° C. rapid freezing resulted in more detail remaining after lyophilization (FIG. 3F).

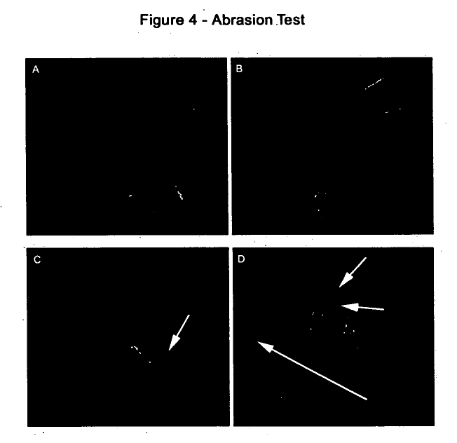

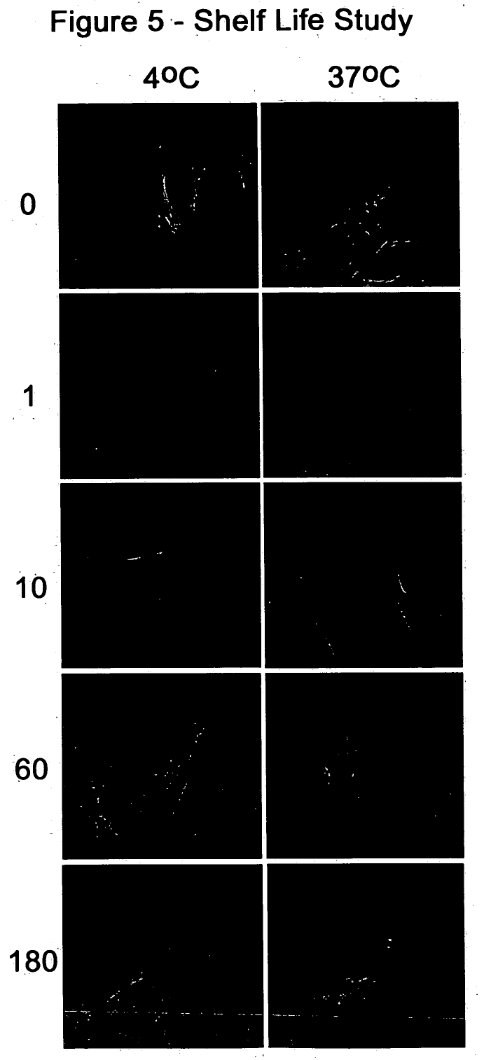

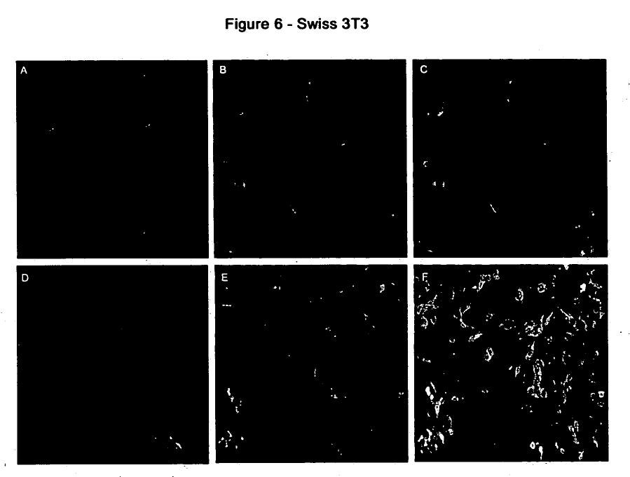

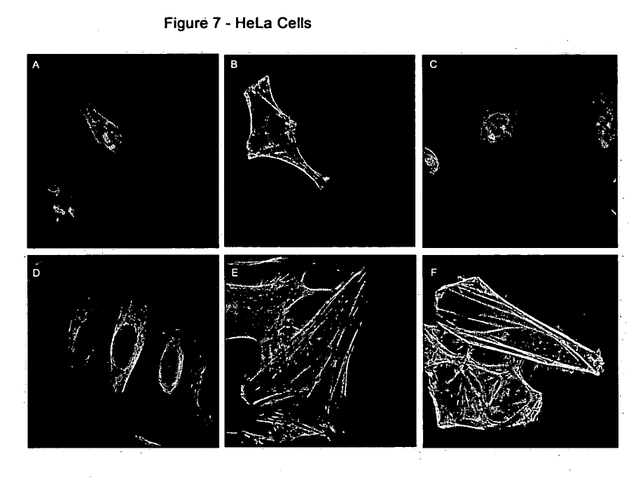

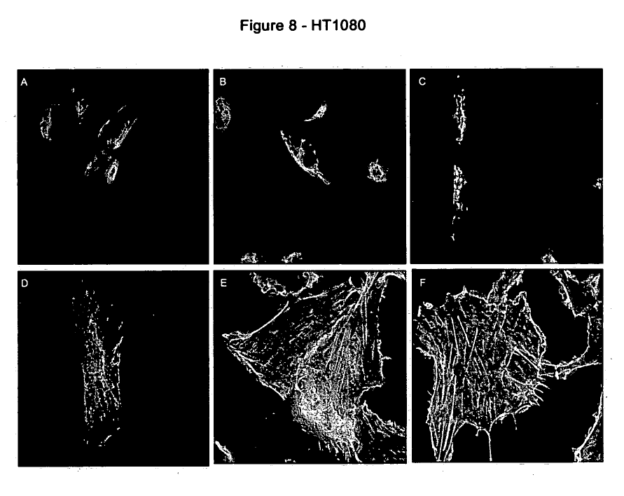

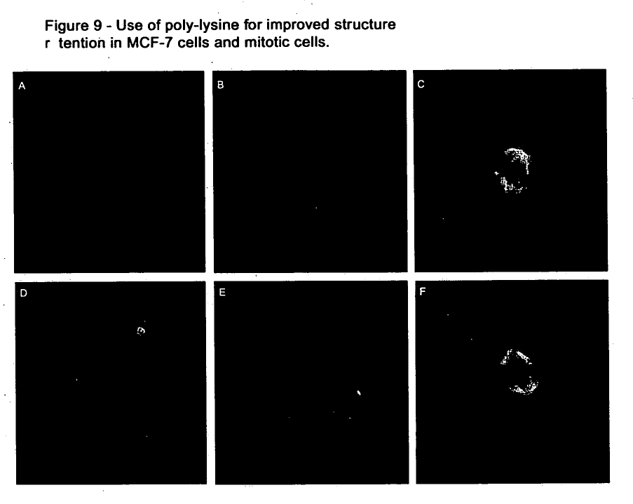

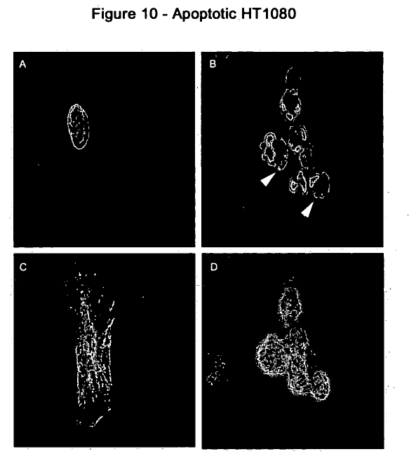

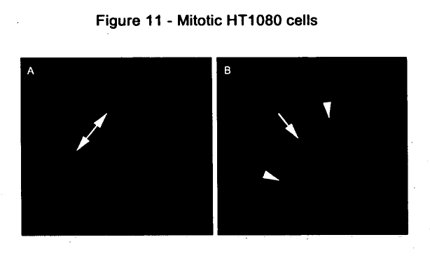

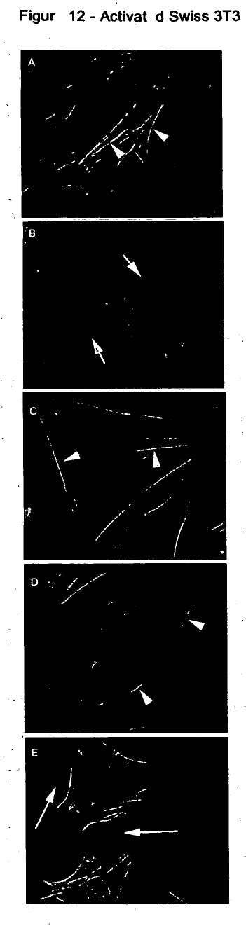

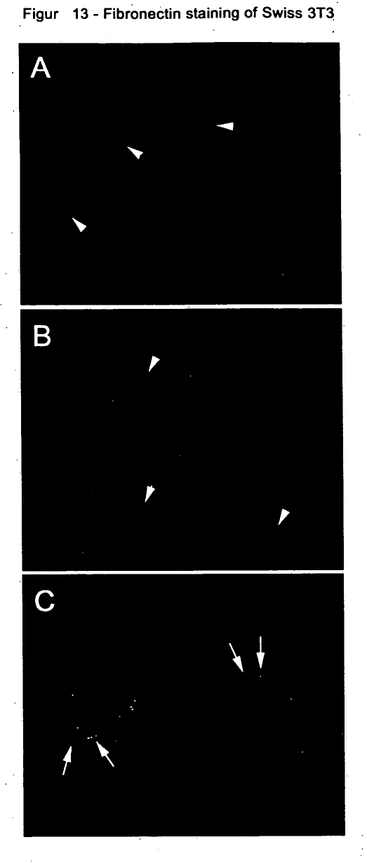

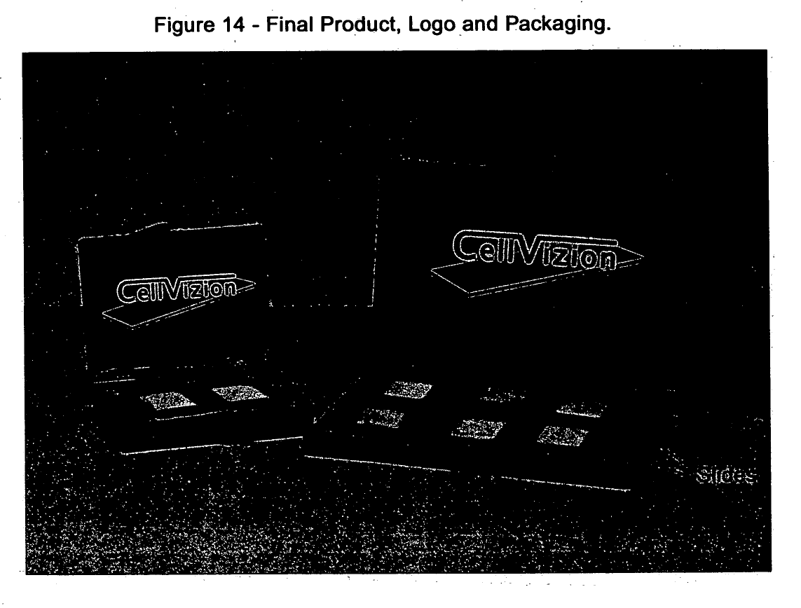

In order to incorporate knowledge of robustness into the invention we performed abrasion tests on lyophilized preparations. We used a light knocking of the slide without actual contact of the powdery surface of the slide and compared this to a light rubbing of the powdery surface and to a scratched surface. FIG. 4 shows that up to the point of light abrasion the cell's structure is not harmed, only scratching removed cells from the glass surface. The conclusion from this experiment is that the preparation is suitable for shipping and handling where the surface can be in minimal contact with the packaging allowing a slight amount of abrasion.

In order to be a valuable commodity the cell preparations must have a shelf life of at least one year. In FIG. 5, we show a batch of Swiss 3T3 that was fixed with methanol, preserved with the same composition as FIG. 2F and stored as described in FIG. 1 at 4° C. or 37° C. for up to 180 days (number noted on the left of the figure). The images represent intact cells stained with anti-tubulin antibody followed by rhodamine anti-sheep secondary antibody. Normal storage temperatures are 4-8° C., whereas 37° C. is used as an accelerated study temperature which is equivalent to eight times the duration at 4° C. (Q₁₀ rule=for every 10° C. increase in temperature there is a two fold increase in reaction rate for a first order reaction [Cell Biology 1979 p125-128 and 152). Therefore 180 days at 37° C. is equivalent to 1440 days or 3.95 years at 4° C. There are intact structures showing molecular detail at all time points upto 180 days at 37° C. indicating that 4 years of storage at 4° C. is feasible.

Our model cell line Swiss 3T3 was used to test different fixatives for their effects on downstream staining (FIG. 6). Anti-tubulin and anti-actin stains probe for all tubulin protein or actin protein respectively. Whereas rhodamine phalloidin stains only filamentous actin which has preserved F-actin conformation (i.e. non-denatured protein conformation), this is an extra depth of molecular detail indicates that the preservation technique preserves not only intracellular localization but also the actual conformation of the protein in each cell. Cells were stored for one month at 4° C. before study because at this time point there was a significant difference between methanol and glutaraldehyde fixed cells in terms of rhodamine phalloidin staining. There is good staining with anti-tubulin and anti-actin in both fixation procedures (see intracellular molecular detail in A,B,D and E), however only the glutaraldehyde fixation (in combination with the preservation method and stored for one month) retains the actual conformation of the original F-actin molecules so that it can bind rhodamine phalloidin (compare the brightness between FIGS. 6C and 6F). Methanol fixed cells are approximately fivefold less bright than glutaraldehyde fixed cells indicating a five fold reduction in retention of F-actin conformation. In extended timeframes i.e. storage at 4° C. up to six months, this phenomena became more exaggerated to a point where there was no longer sufficient staining to visualize any filaments in the methanol fixed samples, in contrast the glutaraldehyde fixed samples retained brightly labeled F-actin indicating effective retention of molecular-scale detail. Therefore the two procedures are delineated, one with methanol which is suitable for all antibody staining because it permeabilizes cells and allows probing even into nuclear regions. The other method with glutaraldehyde is suitable where the actual protein conformation (another depth of molecular detail) is required for probes that require this detail. Both fixation procedures must be performed in combination with the optimized preservation method described here in order to last longer than one week at 4° C. The gradual loss of molecular-scale detail observed with methanol fixation followed by preservation was a general phenomena which was also observed after fixation in PBS, paraformaldehyde and formaldehyde. The fixation procedures can be graded with respect to their effectiveness for preservation of molecular-scale detail in the following series starting with the weakest preserver: PBS<paraformaldehyde<formaldehyde<methanol<glutaraldehyde<glutaraldehyde with poly-lysine coated slides.

We studied HeLa cells (human cervical cancer) in the same manner, they respond differently to methanol fixation than Swiss 3T3. In general with methanol fixation the cellular and intracellular detail is lost, and cells shrivel up on the slide (see FIGS. 7A,B,C). In contrast the glutaraldehyde fixation results in intact cells with intracellular molecular detail (see FIGS. 7D,E,F). This was a common finding, that the less adherent cells (HeLa is less adherent than Swiss 3T3) were recalcitrant to the methanol treatment, but had adequate intracellular detail with glutaraldehyde. The same results were found for HT1080 (see FIG. 8), whereas MCF7 lower quality preserved cell structure which required a different approach to preserve them effectively. In FIG. 9, MCF-7 is grown on polylysine treated glass slides which improves their adherence to the slides, this resulted in adequate retention of the cells on the slide and efficient preservation of molecular structural detail in MCF-7 cells.

As a possible diagnostic tool, apoptotic cells are a model system for analysis. Here we show HT1080 to be well preserved by glutaraldehyde and preservation method described in FIGS. 8D,E,F. Cells were stored for 3 weeks prior to analysis. Paclitaxel was added to cultures 24 h hours before fixation which was sufficient to induce apoptosis. A clear signal of apoptosis is blebbing of nuclear material as clearly seen at the arrowheads in FIG. 10B. In apoptotic cells cytoskeletal architecture is lost, so there is not much detail to be seen when staining with anti-tubulin as in FIG. 10D. Clearly the staining procedure is working as represented by clear microtubule structures seen in the normal preserved cells as shown in FIG. 10C.

Another preparation that is useful in cell biology and diagnostic applications is the mitotic cell. Approximately 1-3% of cells are undergoing mitosis at any one instant during cell culture, mitotic cells are in the part of the cell cycle that is in the process of dividing genetic material to form two nuclei which then form individual nuclei for two daughter cells in a process called cytokinesis. The mitotic index (number of cells in mitosis) can be increased by adding chemicals such as nocodazole which arrest cells in the mitotic part of the cell cycle. Mitosis can be broken down into sub-stages called Prometaphase, Metaphase, Anaphase and Telophase. The image in FIG. 11 is in the telophase of mitosis which means the genetic material has already separated and is being pushed further apart by the mitotic spindle. An abundant component of the mitotic spindle is tubulin, so using anti-tubulin antibodies we can see the molecular detail of the spindle. Clearly the preservation process described here is retaining the mitotic detail. Many Cyclins and other mitotic proteins are expressed or degraded specifically in mitosis so this makes an excellent tool to probe for the location and abundance of these components of mitosis.

As another example of preserving a diagnostically or cell biological relevant cell type is described in FIG. 12. Here we treated cells with growth factors such as lysophosphatidic acid or platelet derived growth factor and indicated the appropriate cell architecture by staining with rhodamine phalloidin. The cells responded normally to these treatments (compare with Rigley and Hall 1993) and the preservation technique retained the intricate molecular strucutre detail associated with each growth factor's appropriate response. Cell preparations were fixed with glutaraldehyde so they could be probed with rhodamine phalloidin to detect conformationally native actin protein in the form of stress fibers (see arrowheads in A). “No serum” control cells had very few stress fibers (see arrows in B). Actin stress fibers were appropriately observed in LPA treated cells (see arrowheads in C). Actin accumulation was appropriately observed in PDGF treated cells (see arrowheads in D). And micro-spikes containing actin fibers were observed as expected in TNFa treated cells (see long arrows in E).

As an example of using the present invention in basic biology, we probed preserved Swiss 3T3 cells treated with the same growth factors as described in FIG. 12 with rhodamine conjugated to fibronectin. Fibronectin binds to receptors on the cell surface when they are conformationally correct. As shown in FIG. 13 fibronectin labels focal adhesion plaques that are known to contain the same fibronectin receptors. This indicates that these preparations have retained fibronectin binding sites (receptors) in the correct conformation.

The final presentation and packaging of the product is shown in FIG. 14. The white colored glass slide represents the lyophilized preservative solution which now protects the cells by creating a layer of dry sucrose which is about 2 millimeters deep, this is compared to the depth of the cell layer which is usually less than 10 micrometers. The packaging shown in FIG. 14 is enclosed in a 6 mil polythene bag with a one unit Trisorb desiccant. This construction will preserve the product for 12 months in a 4° C. cooler, which is usually 100%-humidity environment because of condensation inside the cooler. The product remains at <5% humidity because of the desiccant enclosed in the 6 mil thick polythene bag. Note how the CellVizion logo integrates the name and form of the final product, show clear molecular scale detail on the schematic slide.

Method of Preparation

i) Method of Preparing Methanol Fixed and Lyophilization Preserved Cells

The following procedure is used to preserve methanol fixed cells adhered to coverslips:

Solutions Required:

1. 1000 ml of ISO-temp PBS usually 37° C.

2. 500 ml of methanol at room temperature (rt).

3. 500 ml of Preservative Buffer P. 350 ml of Milli-Q water, 50 ml PBS, 50 ml 50% sucrose and 50 ml of 10% dextran 68 kDal.

Preserving Cells:

1. Pour off culture media and wash cells once with PBS while coverslips are still in Petri dish. Use ISO-temp PBS so as not to disturb cells.

2. Fix cells in 100% methanol at rt for 2 min.

3. Wash once with PBS at room temperature for 30 secs.

4. Pick up coverslips with forceps, shake off excess PBS and place on parafilm, cells side up, in a large Petri dish.

5. Pipette 150 ul of preservative buffer P onto each slide, and place large Petri dish in −70° C. until samples are frozen.

6. Place in lyophilizer and lyophilize overnight starting at 40° C. and ending at 30° C.

7. Next day take out slides and package them in polythene bags with desiccant.

ii) Method of Preparing Glutaraldehyde or Methanol and Glutaraldehyde Fixed and Lyophilization Preserved Cells

The following procedure is used after glutaraldehyde or glutaraldehyde and methanol fixation for preserving tissue culture cells adhered to coverslips.

Solutions Required:

1. 1000 ml of ISO-temp PBS 37° C.

2. 1000 ml of rt PBS 24° C.

3. 1000 ml of 1.0% glutaraldehyde in PBS,

4. 500 ml of Preservative Buffer P. 350 ml of Milli-Q water, 50 ml PBS, 50 ml 50% sucrose and 50 ml of 10% dextran 68 kDal.

Set-Up Required

1. Place 1 L of PBS at in the 37° C. waterbath to warm up (30 min).

2. Fixative, either 1% glutaraldehyde in PBS or 1% glutaraldehyde plus 99% methanol.

3. 24 L Jug containing the 1 L of rt PBS.

4. One scalpel #11 from Feather through Fisher or VWR.

Preserving Cells:

1. Begin by taking the culture plates from the incubator.

2. Aspirate the media by placing the Pasteur pipette into one corner of the plate and tilt the plate towards that corner.

3. For each plate dispense 30 ml of the ISO-temp PBS into the 80 ml beaker and pour into the Petri dish in a place where there are no coverslips. Swirl once gently.

4. Aspirate off the PBS in the same way as for Step 3.

5. For each plate, using the fixative containing beaker measure out 30 ml of fixative and pour on the plate in an area where there are no coverslips.

6. Incubate at rt for 20 min, turn on timer.

7. After the 20 min, aspirate off the fixative solution and pour 30 ml of rt PBS into each plate and swirl once gently.

8. With one plate at a time remove each slide and line them up on one end of the tray.

9. Pipette 150 ul of Preservative on to each slide.

10. Place the tray very carefully into the −70° C. freezer, and be sure it is very flat.

11. Place in lyophilizer and lyophilize overnight starting at 40° C. and ending at 30° C.

12. Next day take out slides and package them in polythene bags with desiccant.

iii) Method of Antibody Staining Preserved or Freshly Prepared Cells.

Coverslips with preserved or non-preserved cells can be processed using in situ immunofluorescence to study the intracellular molecular detail to nanometer scales. The following procedure is similar to that used in the field, for example Antibodies: A Laboratory Manual (1988). Anti-tubulin (1/200) and anti-actin (1/200) primary antibodies (catalog numbers ATN01 and AAN01 from Cytoskeleton Inc. Denver Colo. 80223) are used to probe the cytoskeleton. Anti-mouse rhodamine host goat (1/200, for anti-tubulin) and anti-rabbit rhodamine host goat (1/200, for anti-actin) secondary antibodies were used to detect the location of the primary antibodies. The following procedure was used:

Method

1. For non-preserved cells: Pour off culture media and wash cells once with PBS while coverslips are still in Petri dish. Use ISO-temp PBS so as not to disturb cells.

2. For non-preserved cells: Fix cells in 100% methanol, or 1% glutaraldehyde or a mixture of both for 20 min.

3. For non-preserved cells: Wash once with PBS at room temperature for 30 secs (all steps are performed at room temperature from here on).

From here on the procedure is the same for both preserved and non-preserved cells:

4. Place coverslips on parafilm

5. Block with 3% BSA in PBS for 60 min.

6. Wash once with PBS.

7. Incubate in 1/200 dilution of the primary antibody, use 5 ul antibody in 1 ml PBS plus 3% BSA, incubate for 2 h.

8. Wash three times in PBS plus 1% Triton X-100 (let stand for 5 min each).

9. Incubate in secondary antibody at 1/200 dilution in PBS plus 3% BSA, again for 2 h.

10. Wash three times in PBS (without Triton X-100), let stand for 5 min each.

11. Mount in fixative with anti-fade and visualize under fluorescence microscope.

12. Take images and store files.

Images were taken using a fluorescence microscope (Nikon with Coolsnap software). FIG. 2 shows images from anti-tubulin staining and FIG. 3 with images from anti-actin staining. Samples were stored at 37° C. for up to 4 weeks, using the Q10 rule for biological reactions, this storage time can be used to predict a similar image state after eight months storage at 4° C.

It is clear to see tubulin structure in FIG. 2A, the long threads are polymerized tubulin, called microtubules, which function as tracks in the cell for transporting components through-out the cell. Likewise actin images show filaments of F-actin (polymerized actin) which functions to maintain structural integrity. Considering the images are very similar between the non-preserved and preserved samples it is clear that preserved cells are well maintained during storage.

iv) Staining with Rhodmine-phalloidin

Protocol

All procedures are at room temperature. The following procedure is similar to that used in the field, for example The Cytoskeleton (1992).

1. Slides are removed by cutting the plastic on two side of the slide with a sharp pair of scissors.

2. While wearing gloves, peal back the plastic cover and gently tap out the slide onto a dry clean surface, pick up the slide by its edges and place powdery side up onto a level piece of Parafilm/Nescofilm which is placed in a 9 cm Petri dish (place a 2 cm² piece of wet filter paper in the Petri dish to retain the humidity).

3. Wash once with 200 ul of PBS.

4. Incubate in 150 ul of a 1/200 dilution of the 14 uM rhodanine phalloidin stock, use 5 ul rhodamine phalloidin in 1 ml PBS, incubate for 6 (six) minutes only.

5. Wash three times in 200 ul PBS (let stand for 3 min each).

6. Equilibriate in 200 ul of anti-fade mounting medium, wick off the excess mounting medium and invert onto the glass mounting slide, and seal with with sealing varnish.

7. After sealing agent is completely dry (10 min), then place on microscope stage so that the 0.5 mm CellVizion slide is closest to the objective lens, be carfeul not to crush the slide when focusing, then take images and store files using the “item#, date, replicate number” catalog system. Oil objectives are usually better for sub-cellular detail. (see FIG. 2b for rhodamine phalloidin staining).

Cited USPTO Patents:

| Number | Date | Inventor |
|---|---|---|
| 4559298 | December 1985 | Fahy |
| 5059518 | October 1991 | Kortright et al. |
| 5648222 | July 1997 | Tse et al. |
| 5849517 | July 1996 | Ryan |
| 5879875 | March 1999 | Wiggins et al. |
| 6004762 | December 1999 | Tse et al. |

### Cited Articles

1. Celis; 1994. Cell Biology: A Laboratory Handbook. Editor J. Celis. 1994. Volume 2, Part 8, p355-360. Academic NY.
2. Ridley and Hall 1992. The small GTP-binding protein rho regulates the assembly of focal adhesions and actin stress fibers in response to growth factors. A. J. Ridley and A. Hall. 1992. Cell, 70 (3) p389-399.
3. Nobes and Hall. 1995. Rho, rac and cdc42 GTPases regulate the assembly of multimolecular focal complexes associated with actin stress fibers, lamellipodia, and filopodia. C. D. Nobes and A. Hall. 1995. Cell, 81 (1) p53-62.
4. Harlow and Lane 1988. Antibodies. A laboratory manual. Editors E. Harlow and D. Lane. 1988. Cold Spring Harbor Publications.
5. Carraway and Carraway 1992. The Cytoskeleton. The Practical Approach Series. Editors K. L. Carraway and C. A. C. Caraway. 1992. IRL Press at Oxford University Press, NY. p. 2-3 fixation and phalloidin staining.
Kreis nd Vale 1993. Guidebook to the Cytoskeletal and Motor Proteins. Editors T. Kreis and R. Vale. 1993. Oxford University Press, NY. p. 127 microtubules depolymerize at 4° C.
7. Avila 1990. Microtubule Proteins. Editor J. Avila. 1990. CRC Press, FL.
8. Karp 1979 p697. Cell Biology. p697 for mitosis. Editor G. Karp. 1979. Mcraw-Hill Kogakusha Ltd. (McGraw-Hill Inc.)
9. Karp 1979 p125-128. Cell Biology. p125-128 and 153 for Q₁₀ rule. Editor G. Karp. 1979. Mcraw-Hill Kogakusha Ltd. (McGraw-Hill Inc.)

1. A method of preserving tissue culture cells on glass slides by fixing with glutaraldehyde or methanol, followed by using a preservative agent containing a buffer, a sugar and a carbohydrate polymer, followed by using a rapid freeze step, followed by lyophilization and storage under cool and desiccated conditions.

2. A method as described in claim 1 that results in retention of nanometer scale molecular structure detail.

3. A method as described in claim 1 that results in a product that has a shelf life greater than four years at 4° C.

4. A method as described in claim 1 that produces a preparation of cells on a glass slide.

5. A method as described in claim 1 which is suitable for Swiss 3T3 cells.

6. A method as described in claim 1 which is suitable for HT1080 cells.

7. A method as described in claim 1 which is suitable for HeLa cells.

8. A method as described in claim 1 which is suitable for MCF-7 cells.

9. A method as described in claim 1 which is suitable for other cell lines.

10. A method as described in claim 1 which is suitable for mitotic cell preparations.

11. A method as described in claim 1 which is suitable for apoptotic cell preparations.

12. A method as described in claim 1 which is suitable for growth factor treated cells.

13. A method as described in claim 1 which is suitable for lysophosphatidic acid treated cells.

14. A method as described in claim 1 which is suitable for platelet derived growth factor treated cells.

15. A method as described in claim 1 which is suitable for tumor necrosis factor alpha treated cells.

16. A method as described in claim 1 which is suitable for serum starved cells.

17. A method as described in claim 1 which is suitable for probing of focal adhesion plaques.

18. A method using rhodamine fibronectin as a rapid stain for focal adhesion plaques.
